(19) United States
(12) Patent Application Publication
(10) Pub. No.: US 2021/0120838 A1
(43) Pub. Date: Apr. 29, 2021

(54) Liquid Beverage Mixture

(71) Applicant: Garima Bhuwalka, Houston, TX (US)

(72) Inventor: Garima Bhuwalka, Houston, TX (US)

(21) Appl. No.: 16/947,491

(22) Filed: Aug. 4, 2020

Related U.S. Application Data
(60) Provisional application No. 62/925,755, filed on Oct. 24, 2019.

(51) Int. Cl. A23F 3/14; A23F 3/16; A23L 21/25

(52) U.S. Cl. CPC A23F 3/14; A23L 2/60; A23L 21/25; A23F 3/163

(57) ABSTRACT

A method of manufacturing a liquid beverage concentrate mixture includes, in one embodiment, mixing honey or some other suitable liquid sweetener with powdered tea or tea extract. The liquid beverage concentrate mixture may then be packaged to include individual servings that may be added to water, milk, or any other desired beverage. In one embodiment, the liquid beverage concentrate mixture may be injected or otherwise contained in a dissolvable capsule, such as a gelatin capsule, that may be dropped into a liquid so that the capsule dissolves and mixes the liquid beverage concentrate mixture therein.

### CROSS REFERENCE TO RELATED APPLICATIONS

The present application is a non-provisional of U.S. Provisional Application Ser. No. 62/925,755 entitled Liquid Beverage Mixture, filed on Oct. 24, 2019. All of the foregoing applications are hereby incorporated by reference in their entireties.

### BACKGROUND

### 1. Field of Invention

The present invention relates in general to beverage making, and in particular, to systems and methods for making a consistent tea flavor and strength with the help of tea and a liquid preservative, water-based sweetener medium like honey, without the need for any tea brewing apparatus or filter using a liquid beverage mixture.

### 2. Description of the Prior Art

In traditional tea making, the tea maker typically uses tea, filter tea bag and/or a brewing apparatus. A tea bag typically contains tea (which typically comprises dried, processed and ground leaves of the Camellia Sinensis plant) and acts as a filter as is it either submerged in hot water or placed in a brewing apparatus where hot water is poured through the tea bag. In some other cases, the tea is submerged in hot water and the brewed concoction is poured through a filter to remove the tea particles which may vary from small granulated tea dust all the way to larger tea leaves. The problem with the current method is that there are multiple steps and requirements to produce a consistent taste of tea that includes but is not limited to requirement of some kind of filter, disposal of tea leaves, water temperature, steeping time and quantity of tea that needs to be added to the water. There are multiple attempts towards making tea brewing easier and more consistent but none of them simplify the process for single cup of tea all the way to larger quantities of tea. The objective of this current invention is to provide a simple and quick solution to tea making that can be used in single serving or larger batches without the need for any complicated apparatus. The product and method can be used not just in homes, restaurants and café but can also be used while traveling.

Various efforts have been made to facilitate the tea-brewing process as set forth in the following references, which are hereby incorporated by reference herein:

U.S. Pat. No. 3,163,539 Instant Tea

This invention relates to tea concentrates and tea powders known as instant tea, and to processes for preparing them. More particularly, the invention relates to novel processes for preparing tea extracts which may be concentrated or dried to obtain products which are readily soluble in cold water to produce a tea beverage.

U.S. Pat. No. 10,525,007 Tea Composition for Oral Administration

This invention concerns an enhanced green tea based product for oral use whereby the nutritional and health benefits of green tea, and additives which shall include some combination of flavoring, preservatives, caffeine, humectants, and water, can be ingested and absorbed by the user.

U.S. Application No. 20130224365 Frozen Beverage Portions

A consumer product which includes a honey ingredient and at least a tea ingredient which are mixed together and frozen. The product may further include supplementary flavoring ingredients also frozen with the honey and tea ingredients. The product is adapted to be dissolved in a hot beverage, thereby flavoring a hot beverage. Specifically, the product is adapted to be dissolved in hot water to provide a beverage of sweetened tea.

U.S. Application No. 20160135476 Tea Solid Composition and Process of Making the Same

A tea solid composition comprising a mixture of finely ground tea, a binding agent and water, wherein the mixture forms a tea solid composition in response to heating and subsequent cooling in a mold. The tea solid composition may further include at least one ingredient selected from the group consisting of a sweetener, a ground spice, a flavor extract, a powdered milk product, a color additive and a thickener.

WO Application No. WO2010078192A2 Instantized Plant Based Drink Tablets

The present invention relates to a method of providing a single serving of a plant based aqueous extraction as a drink. A spray dried single serving, for example of red rooibos spray dried powder, is mixed with an effervescing aging, a binding agent and a disintegrant to form a friable table capable of quickly mixing with water for form a tea or coffee type drink or espresso like drink.

CN Application No. CN101731383A Method for Preparing Honey Tea

The invention discloses a method for preparing honey tea, which is characterized in that: the honey tea is prepared by fully mixing honey, tea, ginger powder and tangerine peel powder in a certain proportion, putting the mixture into a container, and sealing the container for 10 to 30 days. The honey tea has the effects of: suppressing cough and moistening lung, dispersing phlegm and transforming qi, clearing heat and detoxicating, promoting appetite and dispersing food, and relieving much tobacco and alcohol, and is suitable for being drunk by people of all ages and both sexes.

KR Patent No. KR101983906B1 Method for Manufacturing Honey Comprising Green Tea

The present invention relates to a method for producing a blending honey containing a green tea as a main component, wherein the green tea honey produced according to the production method of the present invention has a distinctive aroma and taste distinctive to green tea, Because it is low in content, it is easy to eat because it is not sticky or intractable, and it is easily utilized as a part of various foods.

### BRIEF DESCRIPTION OF THE DRAWINGS

The present invention will be better understood on reading the following detailed description of non-limiting embodiments thereof, and on examining the accompanying drawings, in which:

FIG. 1 is a perspective view of an embodiment of a tea straw, in accordance with one embodiment of the present invention;

FIG. 2 is a perspective view of an embodiment of a tea straw, showing one end of the straw that is open, and further showing the liquid beverage concentrate mixture being poured into a glass of liquid such as water, milk, or the like, in accordance with one embodiment of the present invention; and

FIG. 3 is a perspective view of one embodiment of dissolvable gelatin capsules containing the liquid beverage concentrate mixture, wherein the dissolvable gelatin capsules are positioned in the bottom of a glass of liquid such as water, milk, or the like, in accordance with one embodiment of the present invention.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

Embodiments of the present disclosure are directed towards a product and the method for making tea that involves the use of a liquid sweetener and natural preservative 10, such as honey and an extremely fine tea powder 12. The tea powder preferably has an average size in the range of about U.S. mesh sieve nos. 80-1000, or roughly about 177 microns or smaller. The mesh size of the tea powder 12 is preferably so small that when it is mixed in a desired liquid 14, such as water, there is no need to filter the tea particles from the beverage as the particulate of the tea powder 12 is finer than common filters used to remove loose tea leaves from a tea solution. The liquid beverage mixture product 16, in one embodiment, comprises at least one liquid sweetener 10, like honey, that has been blended, mixed and or infused with at least one fine tea powder 12, wherein the mixture may be contained in a straw 18 or straw-like packaging that is sealed on both ends. To make a cup of tea, the liquid beverage mixture 16 contained in the straw 18 can be easily mixed with water or milk or any other liquid 14 of choice to produce a tea solution that can be either cold or hot, as desired. The is liquid beverage mixture 16 can alternatively be packaged in sticks, straws, bottles, pouches, jars, spout bottles, or the like. The method disclosed provides a novel solution to tea making. In accordance with one aspect of this invention, a method for making tea using liquid beverage mixture 16 that in turn has been made using at least honey 10 and fine tea powder 12 is disclosed. This liquid beverage mixture 16 is mixed with a liquid 14 of choice to make a tea solution that is ready for consumption without any additional steps since there is no need for filtration of tea particles or steeping. Honey 10 serves as a natural sweetener and a preservative that is desirable to increase the shelf life of the liquid beverage mixture 16. The liquid beverage mixture 16 works as a sweet tea concentrate without adding processed sugar. The concentrated mixture 16 does not require refrigeration for storage and may be easily mixed with another liquid 14 like water to make sweetened beverage like tea.

In one embodiment, the process for manufacturing the beverage mixture includes the following steps, and it should be understood that these steps may be performed in the following order, or in a different order, and some steps are optional:
1. Raw natural honey 10 is first filtered to remove any major particles.
2. Water content of honey 10 is measured and is preferably less than 20% by weight.
3. If water content is greater than 20%, honey 10 is stored in a cool low humidity place and preferably stirred often until water content drops to 20% or less. Preferably, to perform this step, the honey 10 is stored in a place having a temperature in the range of 50° F. to 80° F., and further, having a humidity level of between 40% and 70%.
4. If honey 10 is crystallized due to any reason, the honey 10 may be heated to around 120° F. to melt any crystals and make sure that the honey 10 has liquid consistency. Preferably, the honey 10 is heated to a temperature within the range of about 110° F. to about 120° F. Frequent stirring is recommended during the heating process to make sure that the honey 10 does not overheat and melts thoroughly.
5. While the honey 10 is in liquid form, tea powder 12 and/or tea extract 12 is slowly added to the honey 10, wherein the tea powder and/or tea extract 12 comprises about 3% to 10% by weight of the liquid beverage concentrate mixture. A mechanical stirrer is preferably used to thoroughly mix the powder(s) 12 and the honey 10 so that the ingredients are mixed thoroughly and all the powder particles 12 are coated with honey 10. This stirring step prevents the powders 12 from settling or separating from the mixture 16. Stirring is preferably continued until the mixture 16 appears homogeneous and desired taste is achieved.
6. Fine powdered tea 12 easily brews itself in the warm honey 10, which naturally contains water. The extra fine powder 12 ensures that the tea is able to brew extremely fast in the mixture 16. If using tea leaf or something similar, the tea will take much longer to infuse in the honey 10 and will tend to either settle or float based on tea characteristics.
7. In one embodiment, the stirrer includes blades like a power blender and may be operated using a drill, although it should be understood that any suitable stirrer or agitating mechanism may be used.
8. Any additional spices/flavoring are added and step 5 is repeated.
9. Tea powder 12, extract, spices or other ingredients are preferably monitored prior to mixing to ensure there are no lumps or large particles that may easily settle.
10. If any ingredient is not available in small enough particle size, it may still be added to the mixture 16 and allowed to infuse its characteristics in to the honey 10. In this case, the mixture 16 is preferably filtered through a fine mesh sieve to remove any larger particles prior to filling.
11. There is no particular order of adding tea powder or extract 12 or other ingredients, but in a preferred embodiment, any larger particles that do not dissolve are added last.
12. It is possible to infuse larger items in the honey 10 (e.g. lavender flowers), filter the honey 10 and then add powders 12 (tea extract).
13. If the particles (e.g. lavender flowers) are too light or too heavy and tend to float or settle easily and do not dissolve, the mixture 16 is preferably either re-agitated, or the container containing the mixture 16 may be flipped upside down so that the ingredients have been infused thoroughly in the mixture 16.
14. Some ingredients may require honey 10 to be heated to a slightly warmer temperature, preferably in the range of 110° F. to 140° F., in order to facilitate the infusion of the ingredient characteristics in to the honey 10.
15. Once a homogeneous mixture 16 is achieved, the product is ready for filling.
16. If filling in a jar, jars should be clean and dry to avoid any contamination.
17. If filling in a straw 10/dissolvable pods such as gelatin capsules 20 or any other format that requires running the mixture 16 through an automatic weighing/filling machine, mixture 16 should be heated and stirred prior to filling in order to maintain proper consistency, and reduce the likelihood that the consistency is not too thick to clog the weighing/filling machine.
18. Typically, the mixture 16 will have at least 85% honey by weight to maintain a liquid format, although it should be understood that the honey percentage may be lower in some embodiments.
19. To make tea, a user simply adds one spoonful of the mixture 16 to a cup of water, milk, or a milk substitute such as almond milk, soy milk, or the like 14 (hot or cold), preferably stirs the mixture 16, and the cup of tea is instantly ready for consumption. This process solves a common customer problem by guaranteeing consistent taste and simplifying tea making process.

During the process of hydration, the tea powder releases water-soluble compounds into the water. This transfer of tea compounds from tea powder to water happens due to a difference in concentration also known as diffusion and is responsible for properties such as color, smell and taste. Due to the extremely fine powder being used, the surface area of tea that comes in contact with water is very high, thus enhancing the diffusion of tea characteristics in to the honey. Also, the fine powder stays dispersed within the honey and does not have a tendency to settle. Over a period of time, due to limited amount of water being present in honey, the tea compound concentration in the liquid beverage mixture reaches equilibrium, thereby preventing any further diffusion of the tea compounds in to the honey and deterioration of taste. The ratio of tea powder to honey is selected based on the desired taste of the final product and natural flavor, color, smell characteristics of the tea powder. Also, by not heating the liquid beverage mixture to higher temperatures above 140 F, the excess absorption of tannins in to the liquid beverage mixture is prevented, thus avoiding excessive bitterness of the mixture. Although traditional tea compounds diffuse in hot water (175F-212 F) within 2-3 minutes, because the current process does not utilize high heat, the infusion may take a few hours to a few days, depending on the nature of the ingredients used in the liquid beverage mixture. Various other fine powders, herbs, spices, solutions and flavorings can be added to the liquid sweetener 10 and fine tea powder 12 while making the liquid beverage mixture 16. In various embodiments, fine tea powder 12 may be replaced by tea extract 12 or tea extract 12 may be added in addition to the tea powder 12. In various embodiments, fine tea powder 12 may be replaced by tea concentrate 12 in powder or solution form or tea concentrate 12 may be added in addition to the tea powder 12.

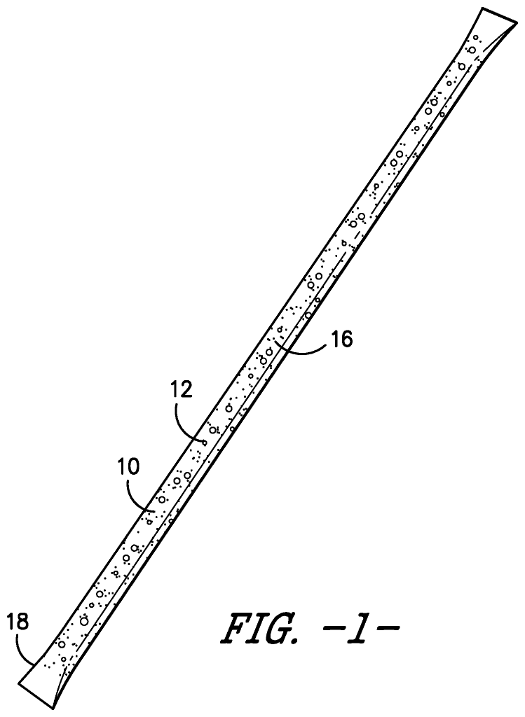

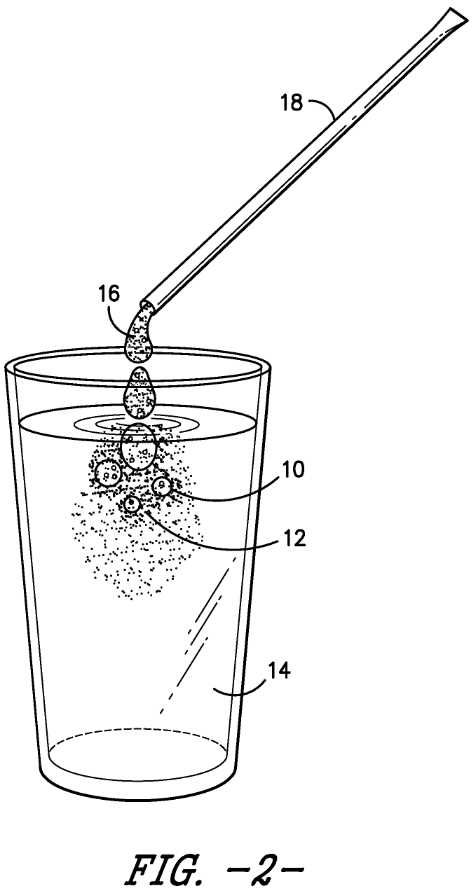

FIG. 1 is a front view of an embodiment of a tea straw 18. In a tea straw 18, the liquid beverage mixture 16 is packaged in a plastic straw 18 and is sealed on both ends. To make a tea solution, the mixture 16 within the straw simply need to be mixed with another desired liquid 14 like milk or water or any other liquid of choice, as shown in FIG. 2. The tea solution is ready for immediate consumption, and it should be understood that the straw 18 may be used to stir to mix the liquid beverage mixture 16 with water 14 or other liquids of choice. The size, material and shape of the tea straw 18 can vary from the embodiment shown in FIG. 1. In one embodiment, the straw is heat-sealed at both ends in such a way that a user may open either end by either squeezing the end of the straw to pop it open, or placing the user's thumb at the base of the seal and flipping upward to pop the end open, similarly to flipping a coin. Such straws are commercially available, and an example is Nature's Kick Honeystix, found online at http://www.originalhoneystix.com/what-are-honeystix-c-44.html. Additionally, the straw or other packaging may include markings indicating amounts of concentrate, so that a user may use only a portion of the liquid beverage mixture within the straw, as measured by the markings thereon.

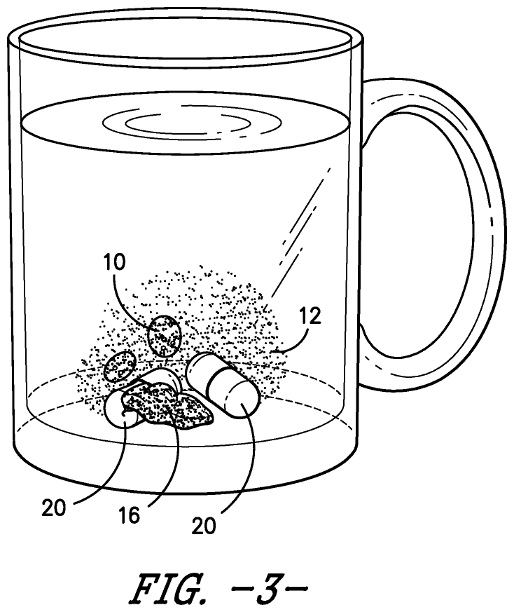

In various embodiments, the packaging material of the liquid beverage mixture 16 can be made of various different materials that include but are not limited to paper, plastic, glass, metal, composite, bio-degradable material. The amount of liquid beverage mixture 16 per package can vary from single serving to multiple servings. It is also contemplated that the liquid beverage mixture may be encapsulated within gelatin capsules 20, or the like, which may be dropped into a cup of hot or cold water, milk, or other desired liquid 14, so that the capsule 20 dissolves and releases the concentrated liquid beverage mixture 16 to form a tea beverage, as shown in FIG. 3.

Alternatively, the liquid beverage mixture 16 can be consumed directly without the need to make a tea solution. It can also be added to other foods or liquid beverages.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent similar purpose, unless expressly stated otherwise. Thus, unless expressly stated otherwise, each feature disclosed is one example only of a generic series of equivalent or similar features.

1. A method for manufacturing a liquid beverage concentrate mixture comprising the steps of:
providing honey in a first container;
determining the percentage of water contained in said honey by weight;
determining whether said honey includes any crystallized particulate;
adding powdered tea and/or tea extract to said honey so that said powdered tea and/or tea extract is in the range of 3% to 10% by weight of the liquid beverage concentrate mixture;
stirring said honey and tea powder and/or tea extract mixture until said mixture is generally homogenous to form a liquid beverage concentrate mixture;
transferring at least a portion of said liquid beverage concentrate mixture to packaging for sale; and
sealing said packaging.

2. The method for manufacturing a liquid beverage concentrate mixture set forth in claim 1, further comprising the step of dehumidifying said honey until said water content of said honey is equal to or less than 20% by weight.

3. The method for manufacturing a liquid beverage concentrate mixture set forth in claim 1, further comprising the step of heating said honey to a temperature in the range of 110° F. to 140° F., in order to melt any said crystalline particulate within said honey.

4. The method for manufacturing a liquid beverage concentrate mixture set forth in claim 1, further including the step of adding additional ingredients or flavorings to said liquid beverage concentrate mixture.

5. The method for manufacturing a liquid beverage concentrate mixture set forth in claim 4, further including the step of filtering said liquid beverage concentrate mixture to remove any large particulate.

6. The method for manufacturing a liquid beverage concentrate mixture set forth in claim 4, wherein said additional ingredients or flavorings are selected from the group consisting of spices, flowers, and fruits.

7. The method for manufacturing a liquid beverage concentrate mixture set forth in claim 1, wherein said packaging is selected from the group consisting of jars, straws, sticks, bottles, pouches, and spout.

8. The method for manufacturing a liquid beverage concentrate mixture set forth in claim 1, wherein said packaging is in a gelatin capsule form.

9. The method for manufacturing a liquid beverage concentrate mixture set forth in claim 9, further including the step of adding said gelatin capsule containing said liquid beverage concentrate mixture to a container of water or milk, so that said gelatin capsule dissolves therein and said liquid beverage concentrate mixture is mixed with said water or milk.

10. The method for manufacturing a liquid beverage concentrate mixture set forth in claim 1, wherein said liquid beverage concentrate mixture contains at least about 85% honey by weight.

11. A natural beverage concentrate comprising a mixture of natural honey and finely ground and sifted powder made from leaves of Camellia Sinensis, wherein said honey and powder are mixed together to impart tea characteristics including flavor and color to the honey to produce a concentrated sweet tea mixture.

12. The natural beverage concentrate set forth in claim 11, further including at least one ingredient selected from the group consisting of a sweetener, spice, a flavor extract, a powdered milk product, a color additive and a thickener.

13. The natural beverage concentrate set forth in claim 11, wherein said natural beverage concentrate is contained in a flexible cylindrical tube that may also be used as a stirrer to stir the beverage in to a second liquid.

14. The natural beverage concentrate set forth in claim 11, wherein said powder includes particulate having an average size in the range of US mesh sieve number 80 or finer.

15. The natural beverage concentrate set forth in claim 11 wherein said honey includes water content in the range of about 15% to 20% by weight.

16. A liquid beverage mixture comprising
at least one water soluble natural preservative liquid having water content that is less than 20% by weight;
tea powder evenly mixed in said liquid; and
wherein said tea powder includes particles having an average size in the range of U.S. mesh sieve nos. 80-1000.

17. The liquid beverage mixture set forth in claim 16, wherein said liquid beverage mixture is contained in a flexible packaging having markings to indicate measured amounts of said liquid beverage mixture to be dispensed therefrom.

18. The liquid beverage mixture set forth in claim 16, wherein said liquid beverage mixture is contained in dissolvable packaging that dissolves in water to produce a sweet tea beverage.

19. A liquid beverage mixture that produces a sweet tea product when diluted with a measured amount of water in a container comprising
a mixture of powdered tea leaves and honey;
wherein said powdered tea leaves include particles having a size in the range of US mesh sieve no. 80-1000;
wherein said liquid beverage mixture can be mixed with a measured amount of water to make sweet tea.

20. The liquid beverage mixture set forth in claim 19, further including a to flexible package containing said liquid beverage mixture, wherein said package includes heat sealed seams that may be popped open by a user by squeezing said heat sealed seams apart.
